(19) United States
(12) Patent Application Publication
(10) Pub. No.: US 2017/0074716 A1
(43) Pub. Date: Mar. 16, 2017

(54) Sensor Verification

(71) Applicant: VEGA Grieshaber KG, Wolfach (DE)

(72) Inventor: Juergen HAAS, Oberwolfach (DE)

(21) Appl. No.: 14/855,680

(22) Filed: Sep. 16, 2015

(51) Int. Cl. G01F 25/00; G01F 23/284

(52) U.S. Cl. CPC G01F 25/0061; G01F 23/284

(57) ABSTRACT

A portable test apparatus for a reflection measuring device includes a first and a second calibration standard of different lengths, a device connector adapted to receive the reflection measuring device for inspection and a selector arrangement adapted to selectably connect the device connector to one of the first or second two calibration standards for providing a calibration pulse in the selected calibration standard is provided.

### FIELD OF THE INVENTION

The present invention relates to a portable test apparatus for a reflection measuring device, a method for providing a measuring device calibration indication using a portable test apparatus, and a non-volatile computer-readable medium.

### BACKGROUND

The level of liquids or solids held in large containers or tanks can be measured using the reflected electromagnetic wave principle. In an example of this approach, a transmission line may be suspended inside the body of a tank, allowing electromagnetic wave impulses to be guided through the body of the tank. The upper end of the transmission line is connected to an electromagnetic wave impulse generator. An impulse generated by the impulse generator is guided along the length of the transmission line.

The pulse eventually crosses a fluid or solid boundary inside the tank or container, defined by the current level of a medium stored in the tank. As the materials either side of the boundary have a different dielectric constant, a reflection is generated which propagates along the transmission line. Some of the energy of the original impulse is reflected back to a measurement device collocated with the impulse generator, and the remainder of the energy propagates to the end of the transmission line, where it the remaining energy reflected by a suitable termination of the transmission line. The level of the fluid or solid material in the container or tank can be assessed by measuring the time-spacing of the reflection with respect to the original impulse, and/or the reference reflection from the terminated end of the line.

To ensure that the correct levels of fluid in a container or tank are reported, verification systems for the impulse generators have been proposed. WO 2014/051482 discusses determining a first measurement value indicative of a time-of-flight of a first electromagnetic reflection signal to a reference reflector and back, and determining a second measurement value indicative of a time-of-flight of a second electromagnetic reflection signal to the reference reflector and back, and determining a verification result based on these measurements. The approach of WO 2014/051482 requires a first distance to be measured with the measurement unit attached to the tank. In a subsequent step, the operator detaches the measurement unit from the tank and attaches the measurement unit to a verification station to measure an electromagnetic signal propagation property of the verification station. Finally, the measurement unit is reattached to the tank to enable the second distance to the reference reflector in the tank to be measured. In addition, the document “Special Documentation, Levelflex FMP53—guided wave radar calibration kit” published as application note SD01003F/00/EN/13.15 71272218 by Endress and Hauser GmbH discusses a guided wave radar calibration kit.

### SUMMARY OF THE INVENTION

According to a first exemplary aspect of the present invention, there is provided a portable test apparatus for a reflection measuring device. The portable test apparatus comprises a first and a second calibration standard each comprising a length of transmission line, wherein the first and the second transmission lines have different electrical lengths. The portable test apparatus comprises a device connector adapted to receive a reflection measuring device for inspection, a selector arrangement adapted to selectably connect the device connector to one of the first or second two calibration standards for providing a calibration pulse in the selected calibration standard, and a processor arrangement adapted to be connected to a data interface of the reflection measuring device which has been connected to the reflection measuring device connector during calibration. The processor arrangement is adapted to generate, using the reflection measuring device under inspection, a first calibration pulse in the first calibration standard, and a second calibration pulse in the second calibration standard, and to receive first calibration measurement data, and second calibration measurement data resulting from measurements of the first and second calibration pulses. The processor arrangement is further adapted to generate a calibration indication using the first and the second calibration measurement data.

Therefore, it is possible to provide multiple calibration standards in a single unit, which may be made more portable. This enables a reflection measuring device to be easily checked for correct operation at the side of an end-user.

According to an embodiment of the first aspect, a portable test apparatus as previously described is provided, wherein the selector arrangement is a manual switch.

Therefore, a user may manually switch between the first and second calibration standards.

According to an embodiment, a portable test apparatus as previously defined is provided, wherein the selector arrangement is an automatic switch adapted to be controlled by the processor arrangement.

Therefore, a processor arrangement may automatically control the selection of the first and the second calibration standards, to enable a simple and automated calibration of a reflection measuring device.

According to an embodiment, the portable test apparatus further comprises a third calibration standard. The processing arrangement is further adapted to receive third calibration measurement data from the reflection measuring device under inspection, wherein the processor arrangement is further adapted to generate the calibration indication using the third calibration measurement data.

Therefore, a more accurate reflection measuring device calibration can be performed, because more calibration measurements are used.

According to an embodiment, the first calibration standard has a length of one metre, the second calibration standard has a length of three metres, and the third calibration standard has a length of five metres.

Therefore, a range of calibration standards, reflecting useful tank or container filling depths is provided, to enable calibration of the portable test apparatus over a wide operating range.

According to an embodiment, a portable test apparatus is provided as described previously. A calibration indication is provided as a data record selected from the group of: a measured length value; a deviation indication: and a “pass-fail” indication.

Therefore, calibration information may be output in different formats. A measured length value and the deviation indication may be useful to a calibration engineer with the task of recalibrating a reflection measuring device. A pass-fail indication may be used by a field service engineer desiring a quick assessment of the functionality of a reflection measuring device.

According to an embodiment, the portable test apparatus comprises an output arrangement connected to the processing arrangement. The processing arrangement is adapted to provide the calibration indication to the output arrangement, and the output arrangement is adapted to display the calibration indication.

Therefore, it may be possible to output the calibration indication to a user, so that action may be taken dependent on the result of the output.

According to an embodiment, the output arrangement is one of a display screen adapted to display the calibration indication to a user, or a data storage interface adapted to provide the calibration indication to a data storage device.

Therefore, it may be possible to display the calibration indication on a screen, or to enable a user to remove calibration information for off-site analysis.

According to an embodiment, the portable test calibration apparatus, further comprises a portable enclosure. The first and second calibration standards, the device connector, the selector arrangement, and the processor arrangement are all enclosed within the portable enclosure.

Therefore, it may be possible to house a portable test apparatus in a compact enclosure, in one example a handheld suitcase or equipment case, so that a field-service engineer can calibrate sensors at the location of their use.

According to an embodiment, a test calibration apparatus is provided, wherein the processing arrangement is adapted to generate the calibration indication using a time domain reflectometry algorithm applied to the first and second calibration measurement data.

Therefore, the length of the first and second calibration standards may be accurately measured.

According to an embodiment, a portable test apparatus is provided wherein the data interface of the reflection measuring device is a 4 . . . 20 mA interface. According to another aspect the apparatus is adapted to connect a two wire device, wherein a two wire device uses a single connection for providing energy to the apparatus under test and/or data.

Therefore, a simple data interface enables the calibration information to be output from the reflection measuring device.

According to an embodiment, a portable test apparatus as previously described is provided, wherein the portable test apparatus is powered using one of a battery, or a solar cell.

Therefore, it is possible to enable a portable test apparatus to be used without a mains electricity supply, or for long periods of time away from a wall-mounted power source.

According to an embodiment, the processor is further configured to compare the calibration measurement data, and second calibration measurement data to known calibration values, and to correct offset errors or pitch errors of a reflection measuring device under inspection via the data interface.

Therefore, a reflection measuring device may be automatically recalibrated whilst close to the place of views of the reflection measuring device.

According to a second exemplary aspect, a method is provided for measuring device calibration indication using a portable test apparatus having first and second calibration standards formed from transmission lines having different electrical lengths. The method comprises the steps of:

connecting a reflection measuring device to a device connector of the portable test apparatus;

selecting a first calibration standard of the portable test apparatus using a selection arrangement;

generating a first calibration pulse in the first calibration standard using the reflection measuring device;

receiving a first calibration measurement data from the reflection measuring device;

selecting a second calibration standard of the portable test apparatus;

generating a second calibration pulse in the second calibration standard using the reflection measuring device;

receiving second calibration measurement data from the reflection measuring device;

generating a calibration indication using the first and the second calibration measurement data.

According to the second aspect of the invention, a reflection measuring device can be calibrated in its application environment.

According to an embodiment, a method is provided which further comprises the steps of: selecting a third calibration standard of the portable test apparatus;

generating a third calibration pulse in the third calibration standard using the reflection measuring device;

receiving the third calibration measurement data from the reflection measuring device;

generating the calibration indication using the third calibration measurement data.

According to an embodiment, a method is provided as described previously, wherein the selection arrangement is an automatic switch adapted to be controlled by the processor arrangement.

According to a third aspect, a non-volatile computer readable medium is provided. The non-volatile computer readable medium comprises code adapted to control a processing arrangement of a portable test apparatus to carry out:

providing a reflection measuring device to a device connector of the portable test apparatus;

selecting a first calibration standard of the portable test apparatus using a selection arrangement;

generating a first calibration pulse in the first calibration standard using the reflection measuring device;

receiving first calibration measurement data from the reflection measuring device;

selecting a second calibration standard of the portable test apparatus;

generating a second calibration pulse in the second calibration standard using the reflection measuring device;

receiving second calibration measurement data from the reflection measuring device;

generating a calibration indication using the first and the second calibration measurement data.

In the following description, the term “reflection measuring device” refers to an item of hardware comprising an electromagnetic wave (radio) transmitter and an electromagnetic wave (radio) receiver with an electromagnetic coupling to a transmission line. The device may be a guided wave radar, wherein the electromagnetic signal is transmitted along a guiding element such as a transmission line. Alternatively, the device may be a free-wave radar, intended to radiate into free-space. The transmitter is configured to transmit a pulse into the transmission line at a known time, and the receiver is configured to receive the radio pulse, or reflections generated therefrom, at subsequent known times. A processor uses a technique such as time domain reflectometry (TDR) to define distances along the transmission line where a reflection might have occurred. Of course, time domain reflectometry is an exemplary method of determining the propagation length, but other methods may be used. This method is also applicable to reflection measurement devices according to a free-radiating radar principle, because the measurement of the correct functioning of the electronics of a free-radiating device may still be verified using lengths of cable. When the transmission line of the reflection measuring device is directed from the top of a tank through the surface of a liquid or solid in a container or measuring tank, a longer reflection time delay indicates that a tank is beginning to get relatively more empty.

Therefore, it can be considered as an alternative view of aspects of the invention to provide an arrangement of components enabling several calibration measurements to be performed close to an application of a reflection measuring device to make calibration, or length measurement accuracy verification to be performed more easily.

These, and other aspects, of the present invention will become apparent from, and be elucidated with reference to, the embodiments described hereinafter.

### BRIEF DESCRIPTION OF THE DRAWINGS

Exemplary embodiments of the invention will be described with reference to the following drawings:

FIG. 1 shows an arrangement of a reflection measuring device in a container or tank according to an exemplary embodiment of the present invention.

FIG. 2 shows a portable test apparatus for a reflection measuring device to an exemplary embodiment of the present invention.

FIG. 3 shows transmission waveforms typically output by a reflection measuring device calibration unit according to an exemplary embodiment of the present invention.

FIG. 4 shows a flow chart of a method in accordance with an exemplary embodiment of the present invention.

FIG. 5 shows a practical arrangement of a portable test device according to an exemplary embodiment of the present invention.

### DETAILED DESCRIPTION

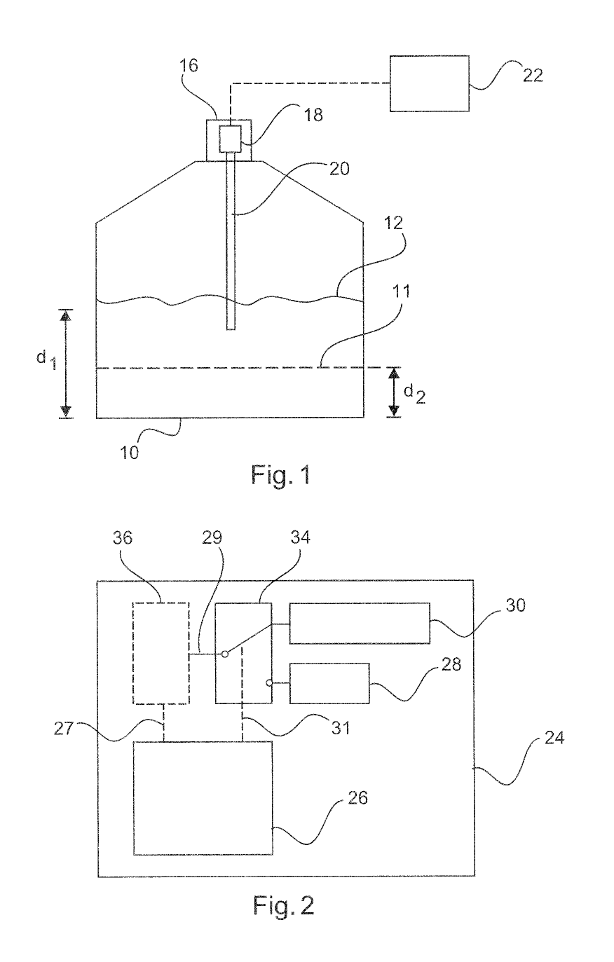

FIG. 1 shows a tank arrangement 10, for example a large oil storage tank as found in the oil industry. The level of oil 12 can vary inside the tank as oil is transferred into the tank from external production units, and as oil is moved out of the tank for consumption. Contracts defining an amount of oil sold are typically priced on the basis of the level of oil measured in the tank before and after oil is delivered to a user downstream. Therefore, it is important that the level of the oil before, and after, the transfer is characterized accurately. It will be appreciated that in other application areas, there is also a need to define the level of a fluid or solid in a tank accurately.

Reflection measuring devices are a successful way to measure the level of fluid in such a tank. A reflection measuring device requires no moving parts (in contrast with the flow switch, for example).

In FIG. 1, a reflection measuring device 16, 18, 20 is shown attached to the top of the tank 10. An enclosure 16 houses analysis circuitry 18 with a radio (electro-magnetic wave) transmitter and receiver (not shown). A radio transmission line 20, such as a coaxial rope, is coupled to the radio transmitter and receiver. The transmission line 20 depends from the enclosure 16 into the body of the tank 10. In an example, the transmission line 20 is a microwave transmission line, and the analysis circuitry 18 generates microwave pulses. A microwave pulse is generally an example of an electromagnetic wave pulse having a frequency in the range of 300 MHz and 300 GHz.

The radio (microwave) signals propagate along the microwave transmission line 20 and are reflected principally at a termination of the transmission line. Other reflections occur at dielectric interfaces traversed by the radio pulse along the propagation path. One such dielectric interface could be an interface between fluid in the tank, and the air above it. Thus, as the fluid level inside the tank 10 varies between an upper level 12 and a lower level 14, the reflection distribution captured by the analysis circuitry 18 will vary. By applying the principles of Time Domain Reflectometry (TDR), the fluid level can be measured.

TDR assumes that the length of the transmission line 20, and other constant parameters affecting the reflection properties of the line, are known in advance, and that the analysis circuitry 18 is operating correctly. Then, accurate TDR results giving the correct fluid level d₁ or d₂ may be calculated from reflections recorded from the transmission line. The TDR results are then reported back to computer 22 for use in contract pricing by an oil vendor, for example. If, however, there is a fault with the analysis circuitry, incorrect TDR results would lead to erroneous level information being produced. Therefore, the analysis circuitry 18 is actively checked for correct functioning.

The approach of the prior art proposes a calibration system which requires measurements from the tank, and a separate calibration standard, to be provided. In other words, the full calibration cycle requires measurements to be made with the sensor attached to the tank, and removed from the tank.

According to an aspect of the invention, a portable test apparatus for a reflection measuring device is provided. The portable test apparatus comprises a first 28 and a second 30 calibration standard each comprising a length of transmission line, wherein the first and the second transmission line have different electrical lengths. Also provided is a measuring device connector 36 adapted to receive a reflection measuring device for inspection. A selector arrangement 34 is provided, adapted to selectably connect the device connector to one of the first and second two calibration standards for providing a calibration pulse in the selected calibration standard. A processor arrangement 26 adapted to be connected to a data interface of the reflection measuring device connected to the device connector 36 during a calibration is provided, wherein the processor arrangement 26 is adapted to generate, using the reflection measuring device under inspection, a first calibration pulse in the first calibration standard 28, and a second calibration pulse in the second calibration standard 30, and to receive the first calibration measurement data, and second calibration measurement data resulting from measurements of the first and second calibration pulses, and wherein the processor arrangement 36 is further adapted to generate a calibration indication using the first and the second calibration measurement data.

FIG. 2 illustrates a portable test apparatus for a reflection measuring device according to an exemplary embodiment of the present invention. The portable test apparatus 24 comprises a processor arrangement 26, a selector arrangement 34, a device connector 36, a first calibration standard 28, and a second calibration standard 30. The processor arrangement 26 is connected to a data interface of the device connector 36 via data interface 27. The processor arrangement 26 is connected to a switching interface of the selector arrangement 34 by a switching interface 31. In the case that the selector arrangement 34 is a manual switch, no switching interface is required, because the selector arrangement 34 would be operated by a user.

A typical reflection measuring device has a data interface, and a radio-frequency interface. In the example of FIG. 2, the data interface 27 is bidirectional, and enables digital data containing tank level measurements to be transferred to a processing device digitally. The data interface however can also be a unidirectional interface. The data interface 27 can carry control signals, instructing a reflection measuring device connected to the device connector 36 to transmit or to receive level measurement signals. The device connector 36 also comprises a balanced transmission line connector 29 connecting the radio-frequency interface of a reflection measuring device under test to an interface of the selector arrangement. Typically, such a balanced line has a standardised impedance of 50 Ohms, for example. Thus, the device connector 36 may be thought of as a multi-function connector enabling the connection of a data interface to a data bus and a radio-frequency interface to a balanced line. In one exemplary embodiment, the combined functionality may be provided in a single connector. However, this is a functional specification, and in an exemplary embodiment, the device connector 36 may also be a co-located set of separate data and radio signal connectors arranged to be plugged into the reflection measuring device seperately.

It will be appreciated that the reflection measuring devices contain on-board electronics comprising discrete logic, logical processing circuitry such as a microprocessor, microcontroller, field programmable gate array (FPGA) or similar configurable and/or programmable digital logic, and analogue front end components such as analogue to digital converters, a radio front end, and power circuitry. The data interface 27 of the device connector 36 is typically a 4 . . . 20 mA (HART) interface, a single or double chamber Modbus™ or Canbus™ interface, an Ethernet interface, a Profibus™ interface, a Foundation Fieldbus™ interface, or other typical networking interface. These interfaces are bidirectional, and enable simulated level data to be provided to the processing arrangement 26 or calculated from the calibration standard, and commands to be given from the processing arrangement 26 to the reflection measuring device. The logical processing circuitry may be loaded with firmware either from on-board memory, or from an attached computer, to enable the reflection measurement device to perform its standard functions.

The selector arrangement 34 is at least a single pole double throw switch capable of selecting between at least two channels, and capable of propagating an electromagnetic (radio) reflection measuring signal whilst adding substantially zero insertion losses or reflections to the test arrangement. As will be described subsequently, the selector arrangement may be manually operated by an operator, or may be automatically operated by the processor arrangement 26. In the illustrated embodiment, the processor arrangement 26 is connected to the selector arrangement 34 by means of a switching interface 31. Therefore, the selector arrangement is adapted to feed an electromagnetic measuring signal from a reflection measuring device under test between two microwave transmission lines (when a reflection measuring device is connected to the device connector 36).

The transmission lines forming the calibration standards 28 and 30 are designed to propagate reflection measuring signals of a reflection measuring system in such a way as to mimic the effect of a genuine guided reflection measuring device installed in a tank. In a preferred embodiment, a coil or length of coaxial line of known length which is terminated at one end with a short-circuit is provided. An open circuit, a resistive load, or a reactive load could be used. The coaxial line would be supplied at a suitable length to the application area, and verified in length by a standardisation process.

As described above, a portable test apparatus is provided which is not provided with a reflection measuring device installed into the device connector 36 initially.

In operation, a user of the portable test apparatus prepares the system by opening up any transportation case the test apparatus is installed in, and by removing a reflection measurement device from its relevant mounting on a tank, installing the reflection measurement device into the device connector 36. This involves connecting a radio-frequency interface of the reflection measuring device to the balanced transmission line 29, and the data interface of the reflection measuring device to the data interface 27.

Before or after this step, the processor arrangement in the portable test apparatus can be initialized. The processor arrangement initializes the reflection measuring device via the data interface 27.

If an automatic selector arrangement 34 is employed, the selector arrangement 34 is set to feed the signal from the device connector 36 a first calibration standard 28. The processor arrangement then instructs a reflection measuring device connected to the device connector 36 to perform a first simulated depth measurement whilst the selector arrangement is arranged in a first position connected to the first calibration standard 28. The reflection measuring device under test will send a radio impulse into the first calibration standard 30, and record the reflections. Using a TDR algorithm, or similar, the length of the first calibration standard 30 is derived, and reported back to the processor arrangement over the data interface 27. The processor arrangement 26 then commands the selector arrangement 34 to change to the second transmission line using the interface 31, or may prompt the user to change the position of a manual selector arrangement 34. The processor arrangement then instructs the reflection measuring device under test to measure a second calibration standard 30. The reflection measuring device calculates the simulated length of a second calibration standard, and reports this value back to the processor arrangement over the data interface 27.

Having obtained several calibration measurements, the processor arrangement is adapted to generate a calibration indication using the first and the second calibration measurements. The calibration indication may involve the processing arrangement 26 comparing the reported lengths transmitted by the reflection measurement device under test with the expected lengths, and calculating a difference between the lengths. Alternatively, a percentage deviation for each standard could be calculated.

Alternatives which may be used in combination with the embodiment described above will now be discussed.

The first and/or second calibration standards 28, 30 may be supplemented without additional calibration standards. For example, a third, a fourth, and/or a fifth, or more calibration standards may be provided, provided the selector arrangement is provided with additional switch terminals.

According to an embodiment, the calibration standards comprise coaxial cables. The coaxial cables may be terminated with a resistive load, or an inductive load, or a capacitive load.

By sizing the length of the coaxial line to standardized lengths, and programming the processor arrangement to select appropriate standard lengths, an accurate time domain reflectometry result can be achieved.

According to an alternative embodiment, the length of the coaxial line of the calibration standard is in the range of 0-10 metres, 0-20 metres, 0-30 metres, 0-40 metres, 0-50 metres, 0-100 metres, or 0-150 metres.

Alternative types of transmission line which would work in accordance with the described aspects comprise microstrip circuits fabricated on a printed circuit board ground plane, or strip line, balanced lines, or twisted pair.

According to an alternative embodiment, the transmission line is calibrated to function in the range of 100 MHz to 3 GHz, 500 MHz to 2.5 GHz, 1 GHz to 2 GHz, or 1.25 GHz to 2.75 GHz. According to a further alternative embodiment, the transmission line is calibrated to function in the range of 75 GHz to 85 GHz, 77.5 GHz to 82.5 GHz, or 79.5 GHz to 80.5 GHz. According to a further alternative embodiment, the transmission line is calibrated to function in the range of 75 GHz to 100 GHz, 100 GHz to 110 GHz, or 110 GHz to 200 GHz.

The selector arrangement 34 may be a manually switched selector arrangement, or may be automatically controlled by the processor arrangement. Connections between the selector switch and the device connector 36 and the calibration standards should preferably be designed to introduce low amounts of spurious reflection into the transmission line.

The processing arrangement 26 may be a laptop computer or a personal computer, with appropriate interfaces capable of communicating with a reflection measuring device under test. Custom software may be loaded onto the processor arrangement (laptop computer) to enable analysis of the reflection measuring device under inspection.

According to an exemplary embodiment, the processor arrangement 26 may be provided with standard models of reflection measuring devices, defining acceptable and unacceptable calibration errors. The processor arrangement 26 may be adapted to generate output information for display to a user, for example a path length of a measured calibration standard, a percentage deviation from an ideal measurement, or simply a pass-fail indication. In addition, the processor arrangement 26 may enable the output of calibration of a reflection measuring device in the form of a .PDF™ document, alternatively the output may be stored on a USB™ stick connected to the processor arrangement.

According to an exemplary embodiment, customer-specific information may be loaded to the processor arrangement 26, so that a .PDF™ report contains customized information such as place of installation, as well as the calibration test results.

According to an exemplary embodiment of the invention, the processor arrangement 26, by means of an output screen, guides an operator in how to test a reflection measuring device connected to the device connector.

According to an aspect of the invention, a method for providing a measuring device calibration indication using a portable test apparatus as provided having first and second calibration standards formed from transmission lines having different electrical lengths. The method comprises the steps of:

connecting 50 a reflection measuring device to a device connector of the portable test apparatus;

selecting 52 a first calibration standard of the portable test apparatus using a selection arrangement;

generating 54 a first calibration pulse in the first calibration standard using the reflection measuring device;

receiving 56 a first calibration measurement data from the reflection measuring device;

selecting 58 a second calibration standard of the portable test apparatus;

generating 60 a second calibration pulse in the second calibration standard using the reflection measuring device;

receiving 62 second calibration measurement data from the reflection measuring device;

generating 64 a calibration indication using the first and the second calibration measurement data.

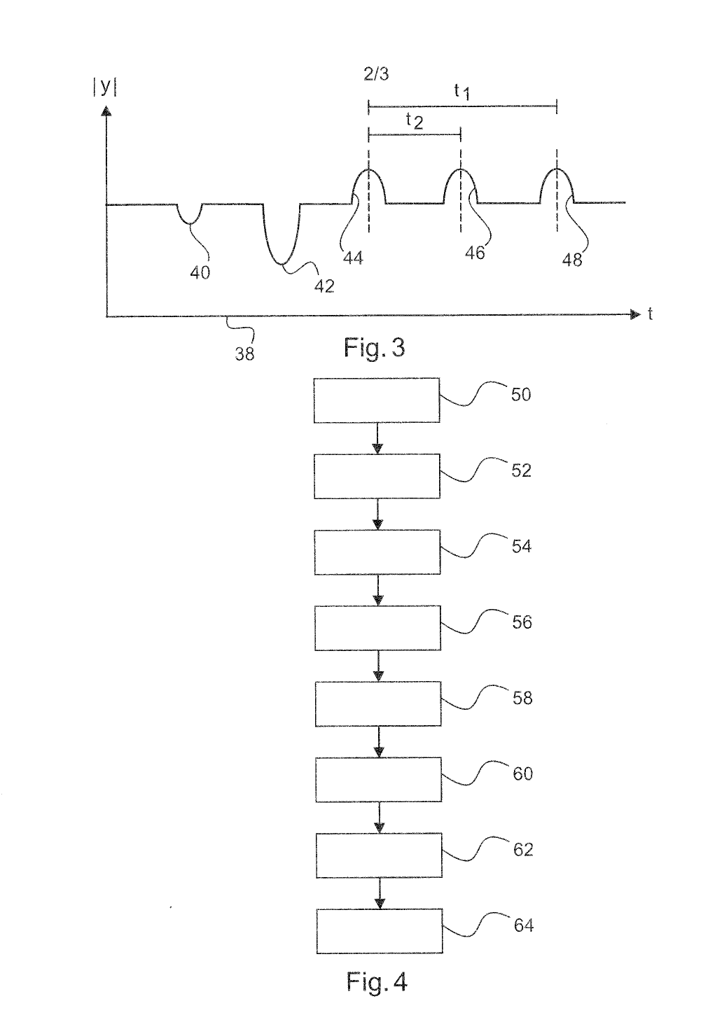

The operation of the method may be appreciated with reference to FIG. 3. Illustrated in FIG. 3 is a superimposed plot showing the magnitude of a calibration measurement signal input into, and recorded from, several calibration standards over time. The reflection measurement device under test transmits pulses into a calibration standard comprising a transmission line. Signal 40 is the reflection caused by the electronics internal reference point, and signal 42 is a minor reflection that could occur at the coupling between the sensor electronic and the device connector 36.

The transmitted pulses are reflected at the end of each transmission lines, as shown by reflections 44, 46, and 48. If the first calibration standard is selected, the reflection signal 44 is detected. If the second calibration standard is selected, the reflection signal 46 is detected. If a third calibration standard is present and selected, the reflection signal 48 is detected. The difference between the times of reception of the echoes t₁ and t₂ are compared to expected values suitable for a relevant calibration standard using the processing arrangement 36. If a deviation between the expected value and the record value is too great, the reflection measurement device under test is defined as being uncalibrated.

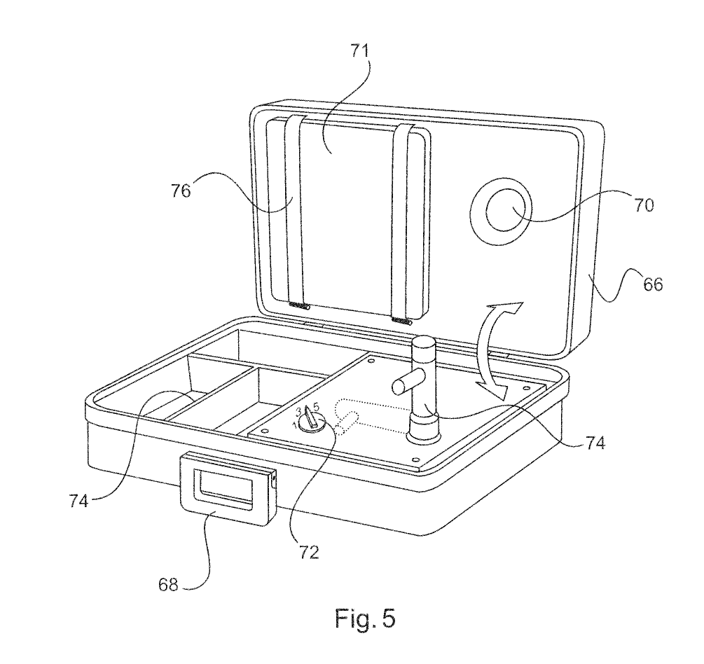

FIG. 5 shows a practical example of the portable test apparatus for a reflection measuring device according to an exemplary embodiment. The portable test apparatus is shown disposed inside a test suitcase 66 which may be carried around by an operator using a handle 68. Illustrated inside the test suitcase are a processor arrangement 71 connected to a data interface of a device connector 74. In FIG. 5, a manual selector arrangement 72 is illustrated. The device connector 74 has a deployed position (showed with black outline) and undeployed (shown with dotted lines) position and therefore may optionally be folded down when not in use. A recess 70 is provided to facilitate storage of the device connector 74. The processor arrangement 71, and other components of the portable test apparatus may be powered by a battery, solar cell, a clock-work (wind-up) generator, for example.

Thus, the test arrangement may be provided in a case having at least two halves which may be folded closed upon each other, to facilitate the transport and use of the test apparatus at a customer location.

In another example the connector may be foldable to allow a compact storage during carrying. A lock may be provided to enable the apparatus to be closed when the apparatus is carried. In another example, the apparatus has a weight of below 5 kg. In particular the weight may be in the range of 1 kg to 3 kg or between 0.5 kg and 2 kg.

In another example, the test suitcase 66 is provided with additional recesses 74 enabling the storage of additional testing electronics. These compartments may be fitted with lids, to enable the storage of loose components or cables. The test suitcase 66 may be provided with restraining straps 76 to enable the stowage of the processor arrangement (laptop computer, netbook) 71.

In the specification, the term “comprising” does not exclude other elements, or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Method steps are not to be construed as being restricted to the order in which they have been recited.

What is claimed is:

1. A portable test apparatus for a reflection measuring device, comprising:
first and second calibration standards, each of the first and second calibration standards comprising a length of transmission line, the first and the second transmission line having different electrical lengths;
a device connector adapted to receive the reflection measuring device for inspection;
a selector arrangement adapted to selectably connect the device connector to one of the first and second two calibration standards for providing a calibration pulse in the selected calibration standard; and
a processor arrangement adapted to be connected to a data interface of the reflection measuring device connected to the device connector during a calibration,
wherein the processor arrangement is adapted to generate, using the reflection measuring device under inspection, a first calibration pulse in the first calibration standard, and a second calibration pulse in the second calibration standard, and to receive first calibration measurement data, and second calibration measurement data resulting from measurements of the first and second calibration pulses, and
wherein the processor arrangement is further adapted to generate a calibration indication using the first and the second calibration measurement data.

2. The portable test apparatus according to claim 1, wherein the selector arrangement is a manual switch.

3. The portable test apparatus according to claim 1, wherein the selector arrangement is an automatic switch adapted to be controlled by the processor arrangement.

4. The portable test apparatus according to claim 1, further comprising:
a third calibration standard,
wherein the processing arrangement is further adapted to receive third calibration measurement data, from the reflection measuring device under inspection, wherein the processor arrangement is further adapted to generate the calibration indication using the third calibration measurement data.

5. The portable test apparatus according to claim 4, wherein the first calibration standard has a length of one metre, the second calibration standard has a length of three metres, and the third calibration standard has a length of five metres.

6. The portable test apparatus according to claim 1, wherein the calibration indication is provided as a data record selected from the group of: a measured length value; a deviation indication; and a “pass-fail” indication.

7. The portable test apparatus according to claim 1, further comprising:
an output arrangement connected to the processing arrangement,
wherein the processing arrangement is adapted to provide the calibration indication to the output arrangement, and the output arrangement is adapted to display the calibration indication.

8. The portable test apparatus according to claim 6, wherein the output arrangement is one of a display screen adapted to display the calibration indication to a user, or a data storage interface adapted to provide the calibration indication to a data storage device.

9. The portable test apparatus according to claim 1, further comprising:
a portable enclosure,
wherein the first and second calibration standards, the device connector, the selector arrangement, and the processor arrangement are enclosed within the portable enclosure.

10. The portable test calibration apparatus of claim 1, wherein the processing arrangement is adapted to generate the calibration indication using a time domain reflectometry algorithm applied to the first and the second calibration measurement data.

11. The portable test apparatus according to claim 1, wherein the data interface of the reflection measuring device is a 4 . . . 20 mA interface.

12. The portable test apparatus according to claim 1, wherein the portable test apparatus is powered using at least one of a battery and a solar cell.

13. The portable test apparatus according to claim 1, wherein the processor is further configured to compare the calibration measurement data, and second calibration measurement data to known calibration values, and to correct offset errors or pitch errors of a reflection measuring device under inspection via the data interface.

14. A method for providing a reflection measuring device calibration indication using a portable test apparatus having first and second calibration standards formed from transmission lines having different electrical lengths, comprising:
providing a reflection measuring device to a device connector of the portable test apparatus;
selecting a first calibration standard of the portable test apparatus using a selection arrangement;
generating a first calibration pulse in the first calibration standard using the reflection measuring device;
receiving first calibration measurement data from the reflection measuring device;
selecting a second calibration standard of the portable test apparatus;
generating a second calibration pulse in the second calibration standard using the reflection measuring device;
receiving second calibration measurement data from the reflection measuring device; and
generating a calibration indication using the first and the second calibration measurement data.

15. The method of claim 14, further comprising the steps of:
selecting a third calibration standard of the portable test apparatus;
generating a third calibration pulse in the third calibration standard using the reflection measuring device;
receiving the third calibration measurement data from the reflection measuring device; and
generating the calibration indication using the third calibration measurement data.

16. The method of claim 14, wherein the selection arrangement is an automatic switch adapted to be controlled by the processor arrangement.

17. A non-volatile computer readable medium comprising code adapted to control a processing arrangement of a portable test apparatus to carry out:
providing a reflection measuring device to a device connector of the portable test apparatus;
selecting a first calibration standard of the portable test apparatus using a selection arrangement;
generating a first calibration pulse in the first calibration standard using the reflection measuring device;
receiving first calibration measurement data from the reflection measuring device;
selecting a second calibration standard of the portable test apparatus;
generating a second calibration pulse in the second calibration standard using the reflection measuring device;
receiving second calibration measurement data from the reflection measuring device; and
generating a calibration indication using the first and the second calibration measurement data.
